(19) United States
(12) Patent Application Publication
(10) Pub. No.: US 2019/0196130 A1
(43) Pub. Date: Jun. 27, 2019

(54) FIBER OPTIC SPLITTER TERMINAL FOR A DISTRIBUTED-SPLIT FIBER OPTIC DISTRIBUTION NETWORK

(71) Applicant: Corning Research & Development Corporation, Corning, NY (US)

(72) Inventors: Alan Duncan Burkett, Bedford, TX (US); Leydys Deniss De Jesus, Huntersville, NC (US); Joshua David Henley, Fort Worth, TX (US); Trampus Lee Landrum, Hickory, NC (US); Andrea Marie Ozuna, Fort Worth, TX (US); Anthony Lynn Williams, Fort Worth, TX (US)

(21) Appl. No.: 16/291,424

(22) Filed: Mar. 4, 2019

Related U.S. Application Data
(63) Continuation of application No. PCT/US17/50090, filed on Sep. 5, 2017.
(60) Provisional application No. 62/383,756, filed on Sep. 6, 2016.

(51) Int. Cl. G02B 6/44

(52) U.S. Cl. CPC G02B 6/4472; G02B 6/4447

(57) ABSTRACT

A fiber optic splitter terminal for a fiber optic distribution network includes a terminal enclosure forming an interior compartment. At least one fiber optic adapter panel is disposed in the terminal enclosure, with a first side facing a first sub-compartment and a second side facing a second sub-compartment, to separate the interior compartment into two distinct areas. A first fiber optic adapter is disposed in the fiber optic adapter panel, and a plurality of second fiber optic adapters are also disposed in the fiber optic adapter panel. One or more splitter modules are disposed at least partially in the first sub-compartment, each comprising a splitter enclosure and a splitter disposed in the splitter enclosure, the splitter having an input leg configured to be optically connected to the first fiber optic adapter and a plurality of output legs optically configured to be connected to the second fiber optic adapters.

### CROSS REFERENCE TO RELATED APPLICATIONS

This application is a continuation of International Application No. PCT/US17/50090, filed on Sep. 5, 2017, which claims the benefit of priority to U.S. Application No. 62/383,756, filed Sep. 6, 2016, both applications being incorporated herein by reference.

### BACKGROUND

The disclosure generally relates to a fiber optic splitter terminal, and more particularly to a fiber optic splitter terminal for a distributed-split fiber optic distribution network or other network.

To provide improved performance to subscribers, communication and data networks are increasingly employing optical fiber. The benefits of optical fiber are well known and include higher signal-to-noise ratios and increased bandwidth. To further improve performance, fiber optic networks are increasingly providing optical fiber connectivity all the way to end subscribers. These initiatives include various fiber-to-the-premises (FTTP), fiber-to-the-home (FTTH), and other fiber initiatives (generally described as FTTx).

In this regard, conventional fiber optic distribution networks provide optical signals from switching points over a distribution network comprised of fiber optic feeder cables. The optical signals may be carried over the fiber optic feeder cables to local convergence points (LCPs). The LCPs act as consolidation points for splicing and making cross-connections and interconnections, as well as providing locations for couplers and splitters. Fiber optic subscriber cables exit the LCPs to carry optical signals between the fiber optic network and a subscriber's premises. Typical subscriber premises include single-dwelling units (SDU), multi-dwelling units (MDU), businesses, and/or other facilities or buildings.

Conventional fiber optic distribution networks typically employ a centralized-split architecture. In a centralized-split architecture, a fiber optic cable is routed to a relatively large centralized-splitter terminal, which may split the fiber optic cable into as many as thirty-two (32) individual subscriber cables. This architecture requires the individual subscribers to be relatively close together, however, and requires a relatively large fiber optic splitter terminal to accommodate the large number of individual subscriber connections.

No admission is made that any reference cited herein constitutes prior art. Applicant expressly reserves the right to challenge the accuracy and pertinence of any cited documents.

### SUMMARY

The disclosure generally relates to a fiber optic splitter terminal, and more particularly to a fiber optic splitter terminal for a distributed-split fiber optic distribution network or other network. One embodiment of the disclosure relates to a terminal comprising a terminal enclosure forming an interior compartment having a first sub-compartment and a second sub-compartment. A fiber optic adapter panel is disposed in the terminal enclosure, with a first side facing the first sub-compartment and a second side facing the second sub-compartment, to separate the interior compartment into two distinct areas. One or more hardened first fiber optic adapters are disposed in the fiber optic adapter panel, and a plurality of second fiber optic adapters are also disposed in the fiber optic adapter panel. One or more splitter modules are disposed at least partially in the first sub-compartment. The splitter module comprises a splitter enclosure and a splitter disposed in the splitter enclosure, the splitter having an input leg and a plurality of output legs. The input leg comprises a first optical fiber having a hardened first fiber optic connector configured to be connected to the hardened first fiber optic adapter on the first side of the fiber optic adapter panel. Each output leg comprises a second optical fiber having a second fiber optic connector configured to be connected to a respective second fiber optic adapter on the first side of the fiber optic adapter panel.

One advantage of these and other embodiments is that the fiber optic splits in a fiber optic distribution network may be distributed across several fiber optic splitter terminals located at different locations in the fiber optic distribution network. This allows the fiber optic splitter terminal to be smaller than a conventional centralized-split fiber optic splitter terminal, at least in part because fewer output fiber optic connections are required. The fiber optic splitter terminal may also be smaller because the placement of components within the interior compartment may be optimized. This arrangement also allows easy expandability of the fiber optic splitter terminal, for example, by replacing a single 1×4 splitter module with a 1×8 splitter module, or adding a second 1×4 splitter module.

In some embodiments, the first fiber optic adapter may be a hardened first fiber optic adapter for connecting a hardened fiber optic connector for a distribution cable, for example. As used herein, the term “hardened” in relation to a fiber optic adapter and/or fiber optic connector refers to environmentally resistant fiber optic adapters and fiber optic connectors that are configured for use in an outdoor (e.g., OSP) environment, such as, for example, Corning Optical Communications'® OptiTap®, OptiTip®, and FlexNAP™ connectivity solutions. In some embodiments, the splitter module may be partially disposed in the second sub-compartment as well, to conserve space in the first sub-compartment. In some embodiments, the splitter module may be a plurality of splitter modules. The plurality of splitter modules may be stacked with respect to each other in the interior compartment.

One embodiment of the disclosure relates to a fiber optic splitter terminal. The fiber optic splitter terminal comprises a terminal enclosure forming an interior compartment having a first sub-compartment and a second sub-compartment. The fiber optic splitter terminal further comprises a fiber optic adapter panel disposed in the terminal enclosure having a first side facing the first sub-compartment and a second side facing the second sub-compartment. The fiber optic adapter panel comprises a hardened first fiber optic adapter disposed in the fiber optic adapter panel, the hardened first fiber optic adapter configured to connect to a distribution cable on the second side of the fiber optic adapter panel. The fiber optic adapter panel further comprises a plurality of second fiber optic adapters disposed in the fiber optic adapter panel, each of the plurality of second fiber optic adapters configured to connect to a respective subscriber cable on the second side of the fiber optic adapter panel. The fiber optic splitter terminal further comprises a splitter module disposed at least partially in the first sub-compartment. The splitter module comprises a splitter enclosure. The splitter module further comprises a splitter disposed in the splitter enclosure. The splitter comprises an input leg comprising a first optical fiber having a hardened first fiber optic connector configured to connect to the hardened first fiber optic adapter on the first side of the fiber optic adapter panel. The splitter further comprises a plurality of output legs, each output leg comprising a second optical fiber having a second fiber optic connector configured to connect to a respective second fiber optic adapter on the first side of the fiber optic adapter panel.

An additional embodiment of the disclosure relates to a fiber optic splitter terminal for a distributed-split fiber optic distribution network. The fiber optic splitter terminal comprises a terminal enclosure forming an interior compartment having a first sub-compartment and a second sub-compartment. The fiber optic splitter terminal further comprises a fiber optic adapter panel disposed in the terminal enclosure having a first side facing the first sub-compartment and a second side facing the second sub-compartment. The fiber optic adapter panel comprises a first fiber optic adapter disposed in the fiber optic adapter panel, the first fiber optic adapter configured to connect to a distribution cable on the second side of the fiber optic adapter panel. The fiber optic adapter panel further comprises a plurality of second fiber optic adapters disposed in the fiber optic adapter panel, each of the plurality of second fiber optic adapters configured to connect to a respective subscriber cable on the second side of the fiber optic adapter panel. The fiber optic splitter terminal further comprises a splitter module disposed at least partially in the first sub-compartment and at least partially in the second sub-compartment. The splitter module comprises a splitter enclosure. The splitter module further comprises a splitter disposed in the splitter enclosure. The splitter comprises an input leg comprising a first optical fiber having a first fiber optic connector configured to connect to the first fiber optic adapter on the first side of the fiber optic adapter panel. The splitter further comprises a plurality of output legs, each output leg comprising a second optical fiber having a second fiber optic connector configured to connect to a respective second fiber optic adapter on the first side of the fiber optic adapter panel.

An additional embodiment of the disclosure relates to a fiber optic splitter terminal for a distributed-split fiber optic distribution network. The fiber optic splitter terminal comprises a terminal enclosure forming an interior compartment having a first sub-compartment and a second sub-compartment. The fiber optic splitter terminal further comprises a fiber optic adapter panel disposed in the terminal enclosure having a first side facing the first sub-compartment and a second side facing the second sub-compartment. The fiber optic adapter panel comprises a plurality of first fiber optic adapters disposed in the fiber optic adapter panel, each of the plurality of first fiber optic adapters configured to connect to a respective distribution cable on the second side of the fiber optic adapter panel. The fiber optic adapter panel further comprises a plurality of second fiber optic adapters disposed in the fiber optic adapter panel, each of the plurality of second fiber optic adapters configured to connect to a respective subscriber cable on the second side of the fiber optic adapter panel. The fiber optic splitter terminal further comprises a plurality of splitter modules disposed at least partially in the first sub-compartment. Each splitter module comprises a splitter enclosure. Each splitter module further comprises a splitter disposed in the splitter enclosure. Each splitter comprises an input leg comprising a first optical fiber having a first fiber optic connector configured to connect to a respective first fiber optic adapter on the first side of the fiber optic adapter panel. Each splitter further comprises a plurality of output legs, each output leg comprising a second optical fiber having a second fiber optic connector configured to connect to a respective second fiber optic adapter on the first side of the fiber optic adapter panel. The plurality of splitter modules are stacked with respect to each other in the interior compartment.

An additional embodiment of the disclosure relates to a distributed-split fiber optic distribution network. The fiber optic distribution network comprises a primary distribution cable. The fiber optic distribution network further comprises a first splitter device having an input optically coupled to an end of the primary distribution cable and a plurality of outputs. The fiber optic distribution network further comprises a plurality of secondary distribution cables each having a first end optically coupled to one of the plurality of outputs of the splitter device and a second end having a hardened fiber optic connector. The fiber optic distribution network further comprises a plurality of fiber optic splitter terminals. Each fiber optic splitter terminal comprises a terminal enclosure forming an interior compartment. Each fiber optic splitter terminal further comprises a fiber optic adapter panel disposed in the terminal enclosure. Each fiber optic adapter panel comprises a first hardened fiber optic adapter disposed in the fiber optic adapter panel, wherein one of the hardened fiber optic connectors of the plurality of secondary distribution cables is connected to the first hardened fiber optic adapter. Each fiber optic adapter panel further comprises a plurality of second fiber optic adapters disposed in the fiber optic adapter panel. Each fiber optic splitter terminal further comprises a splitter module disposed in the interior compartment. Each splitter module comprises a splitter enclosure. Each splitter module further comprises a splitter disposed in the splitter enclosure. Each splitter comprises an input leg comprising a first optical fiber having a hardened first fiber optic connector connected to the hardened first fiber optic adapter. Each splitter further comprises a plurality of output legs, each output leg comprising a second optical fiber having a second fiber optic connector connected to a respective second fiber optic adapter. The fiber optic distribution network further comprises a plurality of subscriber cables optically connected to each of the plurality of second fiber optic adapters of each of the plurality of fiber optic splitter terminals.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic view of a distributed-split fiber optic network system employing distributed fiber optic splitter terminals, according to one embodiment;

FIGS. 2A and 2B illustrate a fiber optic splitter terminal for use in the distributed-split network system of FIG. 1, according to another embodiment;

FIG. 3 illustrates a fiber optic splitter terminal illustrates a fiber optic splitter terminal for use in the distributed-split network system of FIG. 1, according to another embodiment; and

FIG. 4 illustrates a fiber optic splitter terminal illustrates a fiber optic splitter terminal for use in the distributed-split network system of FIG. 1, according to another embodiment.

### DETAILED DESCRIPTION

Various embodiments will be further clarified by the following examples.

The disclosure generally relates to a fiber optic splitter terminal, and more particularly to a fiber optic splitter terminal for a distributed-split fiber optic distribution network or other network. One embodiment of the disclosure relates to a terminal comprising a terminal enclosure forming an interior compartment having a first sub-compartment and a second sub-compartment. A fiber optic adapter panel is disposed in the terminal enclosure, with a first side facing the first sub-compartment and a second side facing the second sub-compartment, to separate the interior compartment into two distinct areas. One or more hardened first fiber optic adapters are disposed in the fiber optic adapter panel, and a plurality of second fiber optic adapters are also disposed in the fiber optic adapter panel. One or more splitter modules are disposed at least partially in the first sub-compartment. The splitter module comprises a splitter enclosure and a splitter disposed in the splitter enclosure, the splitter having an input leg and a plurality of output legs. The input leg comprises a first optical fiber having a hardened first fiber optic connector configured to be connected to the hardened first fiber optic adapter on the first side of the fiber optic adapter panel. Each output leg comprises a second optical fiber having a second fiber optic connector configured to be connected to a respective second fiber optic adapter on the first side of the fiber optic adapter panel. One advantage of these and other embodiments is that the fiber optic splits in a fiber optic distribution network may be distributed across several fiber optic splitter terminals located at different locations in the fiber optic distribution network. This allows the fiber optic splitter terminal to be smaller than a conventional centralized-split fiber optic splitter terminal, because fewer output fiber optic connections are required. The fiber optic splitter terminal may also be smaller because the placement of components within the interior compartment may be optimized. This arrangement also allows easy expandability of the fiber optic splitter terminal, for example, by replacing a single 1×4 splitter module with a 1×8 splitter module, or adding a second 1×4 splitter module.

In some embodiments the first fiber optic adapter may be a hardened first fiber optic adapter for connecting a hardened fiber optic connector for a distribution cable, for example. In some embodiments, the splitter module may be partially disposed in the second sub-compartment as well, to conserve space in the first sub-compartment. In some embodiments, the splitter module may be a plurality of splitter modules. The plurality of splitter modules may be stacked with respect to each other in the interior compartment. In addition, while the terminal is described in connection with a distributed-split fiber optic distribution network in examples herein, it is to be understood that the terminal and components thereof may be used in any telecommunications network and is not limited solely to distributed-split fiber optic distribution networks.

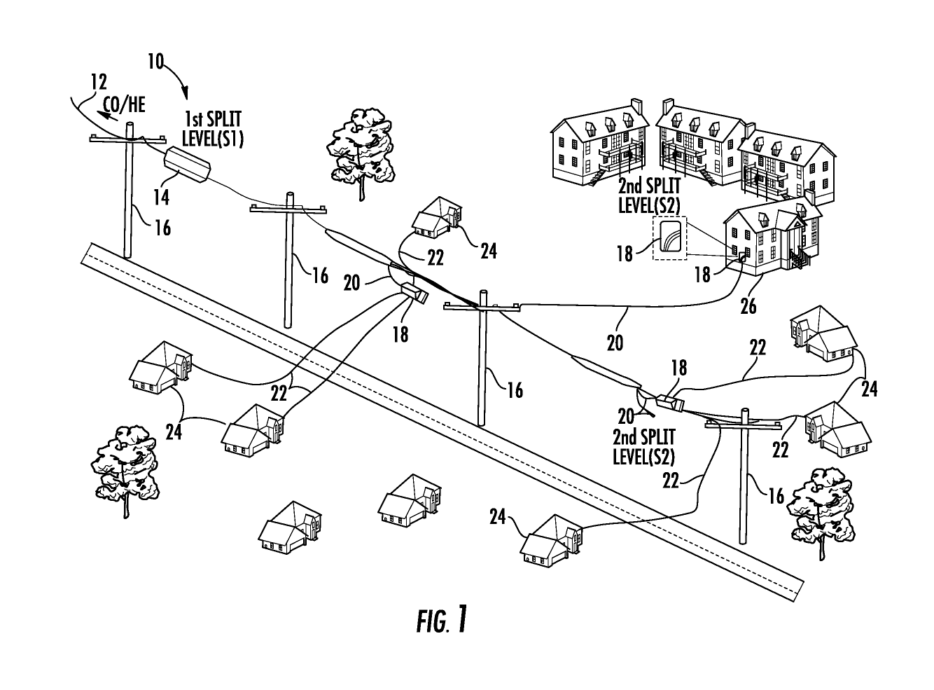

Reference will now be made in detail to the present preferred embodiments, examples of which are illustrated in the accompanying drawings. Whenever possible, the same reference numerals will be used throughout the drawings to refer to the same or like parts. One embodiment of the distributed-split network system is shown in FIG. 1, and is designated generally throughout by the reference numeral 10.

In this regard FIG. 1 illustrates distributed-split network system 10 according to an embodiment. A primary distribution cable 12 is connected to a first splitter 14 that may be located in-line with the primary distribution cable 12 and/or at a utility pole 16. The first splitter 14 is connected to a plurality of fiber optic splitter terminals 18 via a plurality of secondary distribution cables 20. Each fiber optic splitter terminal 18 then splits the respective secondary distribution cable 20 into a plurality of subscriber cables 22, with each subscriber cable associated with a service dwelling 24 or an individual unit within a multiple dwelling unit (MDU) 26, for example. This allows a single primary distribution cable 12 to service dwellings 24 over a larger area and also to service multiple smaller MDUs 26.

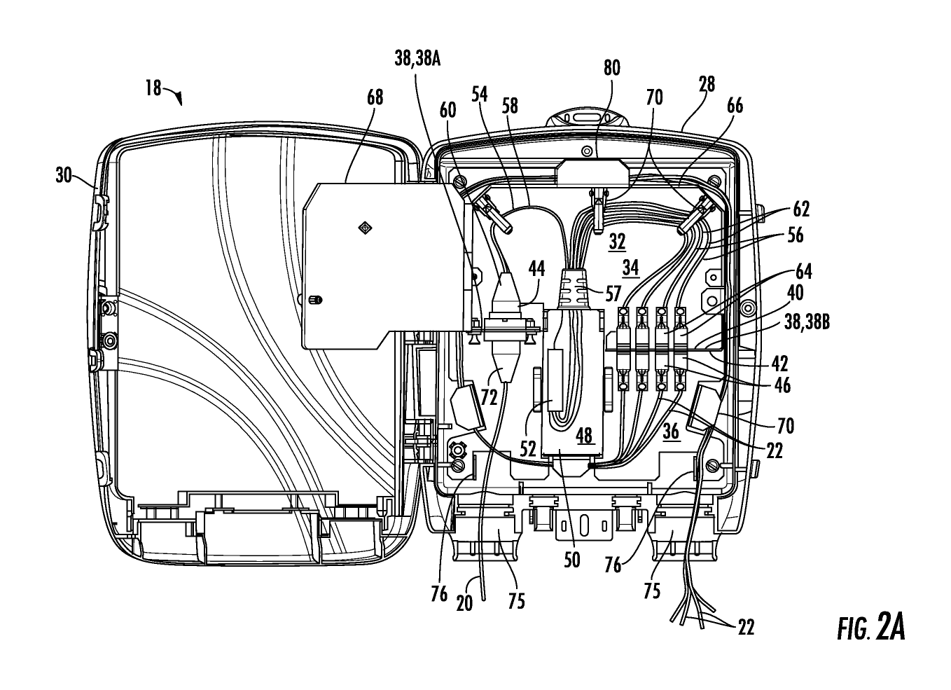

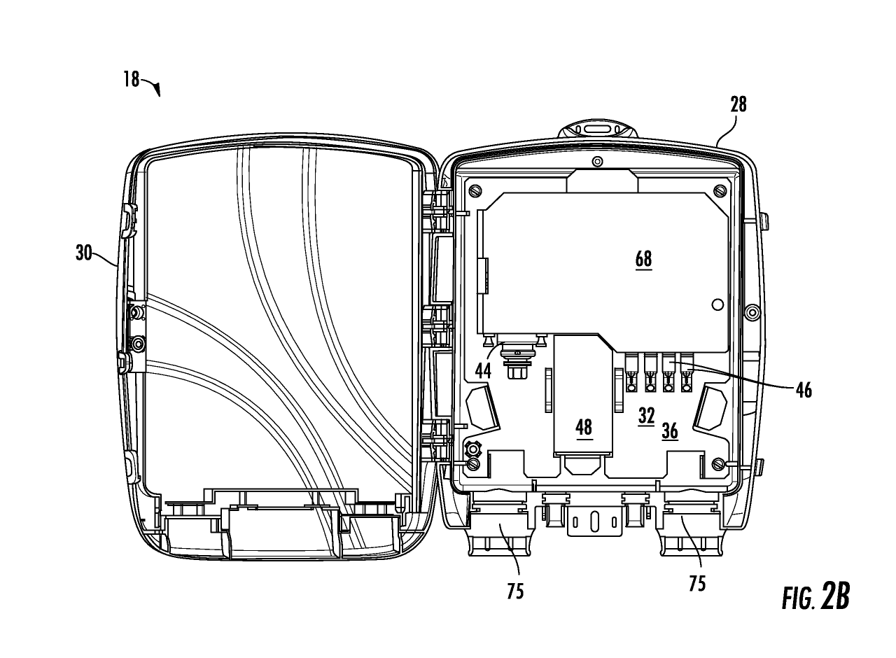

Referring now to FIGS. 2A and 2B, detailed views of the fiber optic splitter terminal 18 of FIG. 1 are illustrated according to an embodiment. The fiber optic splitter terminal 18 comprises a terminal enclosure 28 having a terminal door 30 for allowing access to an interior compartment 32 of the terminal enclosure 28. The interior compartment 32 is divided between a first sub-compartment 34 and a second sub-compartment 36. At least one fiber optic adapter panel 38 is disposed in the terminal enclosure 28, with a first side 40 facing the first sub-compartment 34 and a second side 42 facing the second sub-compartment 36. In this embodiment, the first sub-compartment 34 is at least partially defined by the fiber optic adapter panels 38, and the second sub-compartment 36 is also at least partially defined by the fiber optic adapter panels 38, with each of the fiber optic adapter panels 38 functioning as a divider between the first sub-compartment 34 and the second sub-compartment 36. In the embodiment illustrated in FIGS. 2A and 2B, one or more hardened first fiber optic adapters 44 are disposed in a first fiber optic adapter panel 38A and a plurality of second fiber optic adapters 46 are disposed in a second fiber optic adapter panel 38B. In other embodiments, the fiber optic splitter terminal 18 may include a single fiber optic adapter panel 38 and the one or more hardened first fiber optic adapters 44 and the plurality of second fiber optic adapters 46 are disposed in the single fiber optic adapter panel 38. In yet other embodiments, the fiber optic splitter terminal 18 may include a plurality of fiber optic adapter panels 38 and the one or more hardened first fiber optic adapters 44 and the plurality of second fiber optic adapters 46 are all disposed in just one fiber optic adapter panel 38 of the plurality of fiber optic adapter panels 38 rather than being located on separate fiber optic adapter panels 38 as illustrated in FIGS. 2A and 2B.

One or more splitter modules 48 are disposed at least partially in the first sub-compartment 34. In this embodiment, the splitter module 48 is also partially disposed in the second sub-compartment 36, disposed in a gap between the fiber optic adapter panels 38, to conserve space in the first sub-compartment 34. The splitter module 48 comprises a splitter enclosure 50 and a splitter 52 disposed in the splitter enclosure 50, the splitter 52 having an input leg 54 and a plurality of output legs 56. In this embodiment, the input leg 54 and output legs 56 are routed into and out of the splitter enclosure 50 through a strain relief boot 57, and are enclosed and protected within the first sub-compartment 34. A first optical fiber 58 has a hardened first fiber optic connector 60 connected to the hardened first fiber optic adapter 44 on the first side of the fiber optic adapter panel 38. A plurality of second optical fibers 62 each have a second fiber optic connector 64 connected to a respective second fiber optic adapter 46 on the first side of the fiber optic adapter panel 38. It should be understood that other types of cables, adapters, and connectors may be used. For example, the second fiber optic adapters 46 could be MPO-type (standard or hardened) adapters. In this example, as fiber counts increase, e.g., to a forty-eight (48) fiber split, an indoor-rated MPO connection may be commercially desirable.

In this embodiment, the fiber optic adapter panels 38 form part of a sub-enclosure 66 surrounding the first sub-compartment 34. The sub-enclosure 66 includes a sub-enclosure door 68 for isolating and selectively accessing the first sub-compartment 34 during installation and servicing. In this embodiment, the sub-enclosure door 68 aligns with the fiber-optic adapter panels 38 when the sub-enclosure door 68 is closed, to further define the sub-enclosure 66. The sub-enclosure door 68 is open in FIG. 2A, and the sub-enclosure door 68 is closed in FIG. 2B. When access to the second sub-compartment 36 does not require access to the first sub-compartment 34, such as when connecting or changing secondary distribution cables 20 and/or subscriber cables 22 within the fiber optic splitter terminal 18, the sub-enclosure door 68 can remain closed to restrict access to and protect the components within the first sub-compartment 34, such as the input leg 54 of the splitter module 48 and the plurality of output legs 56 of the splitter module 48. In some embodiments, the sub-enclosure 66 or other components may be a selectively removable, modular component, which may be part of a unified product platform with interchangeable components. One advantage of forming these and other components of the fiber optic splitter terminal 18 as modular components and/or as part of a unified product platform is that different mechanically isolated components relating to splitting, connectivity, furcation, etc., may be added or removed to the fiber optic splitter terminal 18 in a plug-and-play arrangement. In some embodiments, the sub-enclosure door 68 may include a tab, protrusion, or other feature (not shown) configured to engage the splitter module 48 when the sub-enclosure door 68 is in a closed position. This allows the sub-enclosure door 68 to secure and/or lock the splitter module 48 in place, and may also function to further define and enclose the first sub-compartment 34.

In this embodiment, a plurality of cable management features 70 may be disposed in the first sub-compartment 34 and the second sub-compartment 36. In this embodiment, the secondary distribution cable 20 is connected to the hardened first fiber optic adapter 44 via another hardened fiber optic connector 72, and each subscriber cable 22 is connected to a respective second fiber optic adapter 46 by a respective fiber optic connector 74. In this embodiment, the secondary distribution cable 20 and the subscriber cables 22 may be routed into and out of the fiber optic splitter terminal 18 via one or more conduits 75. The interior compartment 32 may also include one or more strain relief tabs 76 configured to attach to the fiber optic cables 20, 22 and/or fiber optic connectors 72, 74, for example.

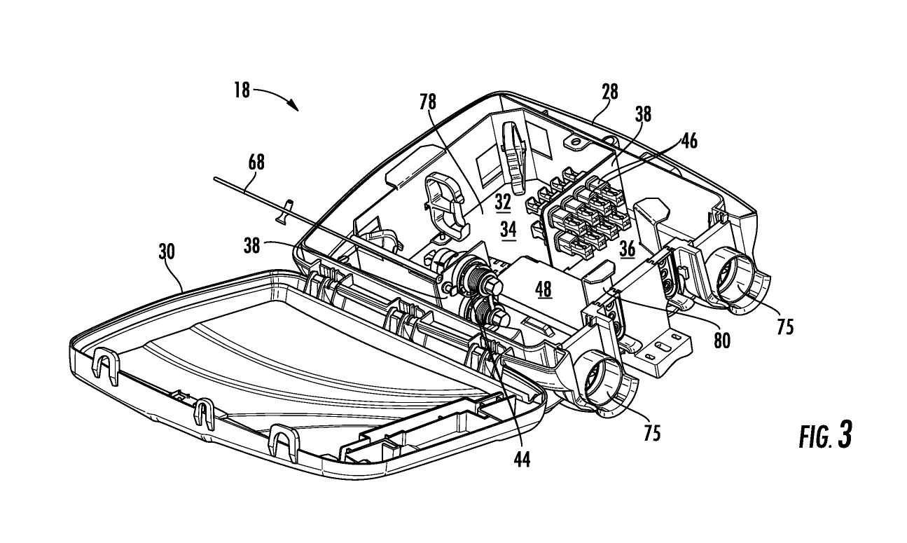

FIG. 3 is a perspective view of the fiber optic splitter terminal 18 of FIG. 2 with some elements removed, in order to illustrate details of the fiber optic splitter terminal 18. In this regard, as noted above, the splitter module 48 may include a hardened splitter enclosure 50, which protects the splitter 52 during installation and servicing of the fiber optic splitter terminal 18. The hardened splitter enclosure 50 makes the splitter module 48 significantly larger, however. In this embodiment, the hardened splitter enclosure 50 may be located partially within the first sub-compartment 34 and partially within the second sub-compartment 36. This increases the available space within the first sub-compartment 34 while still allowing the sub-enclosure door 68 to be closed to isolate the first sub-compartment 34. This arrangement also allows access to the second sub-compartment 36 by an installer or technician, for example, without exposing the components of the splitter 52 to accidental damage, and provides adequate space for routing and storage of optical fibers in both the first sub-compartment 34 and the second sub-compartment 36.

In one embodiment, a capacity of the fiber optic splitter terminal 18 may be increased by replacing the modular splitter module 48 and/or by installing additional splitter modules 48. For example, the fiber optic splitter terminal 18 may be initially installed with a 1×4 splitter module 48 in an MDU 26 (see FIG. 1) to service up to four dwellings in the MDU 26. As the take rate for fiber optic services increases, the 1×4 splitter module 48 may be replaced with a 1×8 splitter module 48, with additional second optical fibers 62 optically connected to previously unused second fiber optic adapters 46. In another embodiment, capacity of the splitter module 48 may by increased by adding additional splitters 52 in the splitter enclosure 50.

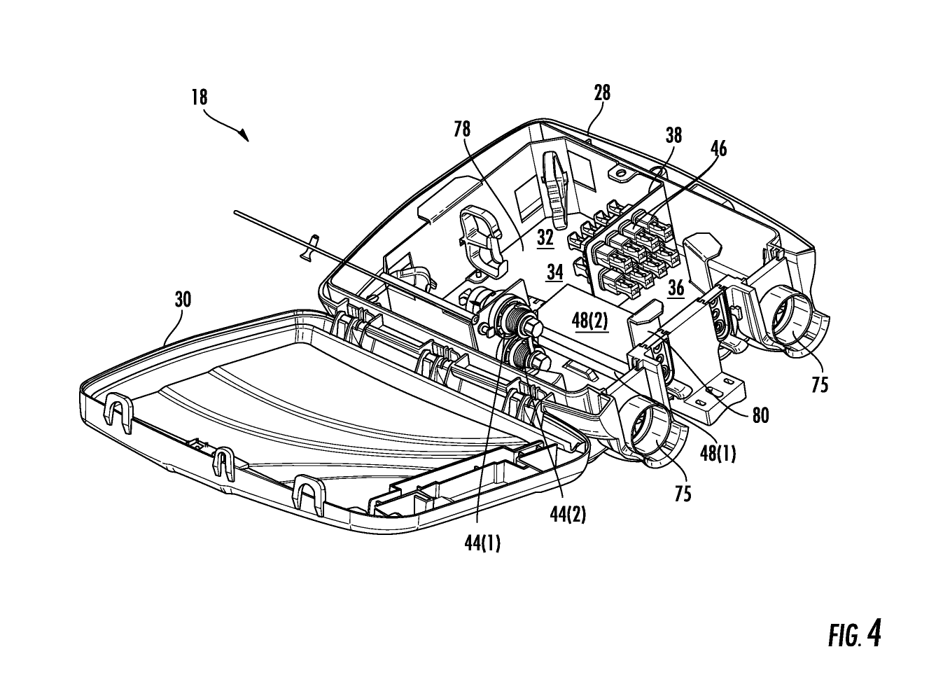

In this regard, FIG. 4 is a perspective view of the fiber optic splitter terminal 18 of FIGS. 2 and 3 with multiple splitter modules 48 installed. In this embodiment, a first 1×4 splitter module 48(1) is positioned between the fiber optic adapter panels 38 against a rear wall 78 of the fiber optic splitter terminal 18. To increase splitter capacity of the fiber optic splitter terminal 18, a splitter enclosure 50 of a second 1×4 splitter module 48(2) is stacked over the splitter enclosure 50 of the first 1×4 splitter module 48(1). In this embodiment, the fiber optic adapter panel 38 includes a pair of hardened first fiber optic adapters 44 in a stacked arrangement. This permits a pair of secondary distribution cables 20 to be optically connected to respective input legs 54 of the respective splitters 52 (not shown). This also permits a single secondary distribution cable 20 to be connected to the first splitter module 48(1) at a first time, when the distributed-split fiber optic network 10 is relatively small, and another secondary distribution cable 20 to be connected to the second splitter module 48(2) at second time, as the distributed-split fiber optic network 10 grows. In another embodiment, a single secondary distribution cable 20 may be split between the fiber optic adapter panel 38 and the input legs 54 (not shown), to connect to both input legs 54.

In this embodiment, the splitter enclosures 50(1), 50(2) are shaped to be stackable between the fiber optic adapter panels 38 and may also abut one or more cable management features 70, such as cable management tab 80 in this embodiment, to retain the splitter enclosures 50(1), 50(2) in place within the interior compartment 32. As discussed above, this allows space within the first sub-compartment 34 to be conserved, thereby allowing the overall size of the fiber optic splitter terminal 18 to be minimized while continuing to provide protection for the splitters 52 within the splitter modules 48.

One advantage of these and other embodiments of this disclosure is that an outside/inside fiber optic splitter terminal 18 with splitters 52 for smaller MDUs 26 may be provided using a distributed-split architecture. The disclosed embodiments also allow for smaller individual fiber optic splitter terminal 18 footprints, greater scalability at lower cost, and compatibility with outside plant hardened plug-n-play FTTx solutions, such as Corning Optical Communications'® OptiTap®, OptiTip®, and FlexNAP™ connectivity solutions. These solutions may also be integrated with related FTTx features, such as indexing. Unlike conventional centralized-split architectures, which may use larger traditional outside plant (OSP) terminals that may not be aesthetically appealing to the MDU building owners, the smaller fiber optic splitter terminals 18 in the disclosed distributed-split fiber optic networks 10 are small enough to match existing copper-based terminals that may already be present in an MDU 26 installation.

These and other embodiments allow a telecommunications service provider to grow a distributed-split fiber optic network, such as the distributed-split fiber optic network 10 of FIG. 1, using a flexible, versatile, and user-friendly fiber optic splitter terminal 18. In some embodiments, the fiber optic splitter terminal 18 may use a form factor similar to industry standard housings, with which installers and technicians may be familiar. The disclosed embodiments also allow the connection of an outside plant, environmentally hardened OptiTap® and/or OptiTip® connector to feed directly to an input leg 54 of a splitter 52 inside the fiber optic splitter terminal 18. The hardened first fiber optic adapter 44, which may be a single fiber OptiTap® adapter, can feed the 1×4 or 1×8 splitter module(s) 48.

As discussed above, the ability to change/switch/interchange the splitter module 48 split ratio (from a 1×4 or two 1×4s to a 1×8, or vice versa) allows flexibility for growing and/or modifying the distributed-split fiber optic network 10 design by moving different capacity splitter modules 48 to different locations in the distributed-split fiber optic network 10 as needed. This allows versatility and flexibility in current and future distributed-split fiber optic network 10 designs. The fiber optic splitter terminal 18 also allows re-access to some or all sub-compartments 34, 36 of the fiber optic splitter terminal 18 following installation, whereas many conventional sealed terminals do not allow access to the terminals following installation. This permits the distributed-split fiber optic network 10 to adjust, grow, and/or change to accommodate current service needs. For example, the distributed-split fiber optic network 10 architecture also allows for additional layers of splitter modules 48 to be located upstream or downstream, in a daisy-chain configuration of fiber optic splitter terminals 18, for example, in response to changes in demand for fiber optic service among area service dwellings 24 and/or MDUs 26.

It will be apparent to those skilled in the art that various modifications and variations can be made without departing from the spirit or scope of the invention.

Further, as used herein, it is intended that terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. Likewise, other types of suitable optical fibers include bend-insensitive optical fibers, or any other expedient of a medium for transmitting light signals. An example of a bend-insensitive, or bend resistant, optical fiber is ClearCurve® Multimode fiber commercially available from Corning Incorporated. Suitable fibers of this type are disclosed, for example, in U.S. Patent Application Publication Nos. 2008/0166094 and 2009/0169163.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A fiber optic splitter terminal comprising:
a terminal enclosure forming an interior compartment having a first sub-compartment and a second sub-compartment;
at least one fiber optic adapter panel disposed in the terminal enclosure having a first side facing the first sub-compartment and a second side facing the second sub-compartment, the at least one fiber optic adapter panel comprising:
a hardened first fiber optic adapter disposed in the at least one fiber optic adapter panel, the hardened first fiber optic adapter configured to connect to a distribution cable on the second side of the fiber optic adapter panel; and
a plurality of second fiber optic adapters disposed in the at least one fiber optic adapter panel, each of the plurality of second fiber optic adapters configured to connect to a respective subscriber cable on the second side of the at least one fiber optic adapter panel; and
a splitter module disposed at least partially in the first sub-compartment, the splitter module comprising:
a splitter enclosure;
a splitter disposed in the splitter enclosure, the splitter comprising:
an input leg comprising a first optical fiber having a hardened first fiber optic connector configured to connect to the hardened first fiber optic adapter on the first side of the at least one fiber optic adapter panel; and
a plurality of output legs, each output leg comprising a second optical fiber having a second fiber optic connector configured to connect to a respective second fiber optic adapter on the first side of the at least one fiber optic adapter panel.

2. The fiber optic splitter terminal of claim 1, wherein the first sub-compartment comprises a sub-enclosure door.

3. The fiber optic splitter terminal of claim 2, wherein the sub-enclosure door is configured to engage the splitter module when the sub-enclosure door is in a closed position.

4. The fiber optic splitter terminal of claim 3, wherein the sub-enclosure door isolates the first subcompartment when the sub-enclosure door is in the closed position.

5. The fiber optic splitter terminal of claim 4, wherein the input leg of the splitter module and the plurality of output legs of the splitter module are protected when the sub-enclosure door is in the closed position.

6. The fiber optic splitter terminal of claim 2, wherein the sub-enclosure door aligns with the at least one fiber optic adapter panel.

7. The fiber optic splitter terminal of claim 3, wherein the sub-enclosure door engages the splitter module when the sub-enclosure door is in the closed position.

8. The fiber optic splitter terminal of claim 1, wherein the at least one fiber optic adapter panel comprises a first fiber optic adapter panel and a second fiber optic adapter panel, wherein the first fiber optic adapter panel comprises the hardened first fiber optic adapter and the second fiber optic adapter panel comprises the plurality of second fiber optic adapters.

9. A fiber optic splitter terminal, comprising:
a terminal enclosure forming an interior compartment having a first sub-compartment and a second sub-compartment;
at least one fiber optic adapter panel disposed in the terminal enclosure having a first side facing the first sub-compartment and a second side facing the second sub-compartment, the at least one fiber optic adapter panel comprising:
at least one first fiber optic adapter disposed in the at least one fiber optic adapter panel, the at least one first fiber optic adapter configured to connect to a distribution cable on the second side of the at least one fiber optic adapter panel; and
a plurality of second fiber optic adapters disposed in the at least one fiber optic adapter panel, each of the plurality of second fiber optic adapters configured to connect to a respective subscriber cable on the second side of the at least one fiber optic adapter panel; and
a splitter module disposed at least partially in the first sub-compartment and at least partially in the second sub-compartment, the splitter module comprising:
a splitter enclosure;
a splitter disposed in the splitter enclosure, the splitter comprising:
an input leg comprising a first optical fiber having a first fiber optic connector configured to connect to the at least one first fiber optic adapter on the first side of the at least one fiber optic adapter panel; and
a plurality of output legs, each output leg comprising a second optical fiber having a second fiber optic connector configured to connect to a respective second fiber optic adapter on the first side of the at least one fiber optic adapter panel.

10. The fiber optic splitter terminal of claim 9, wherein the at least one first fiber optic adapter is hardened.

11. The fiber optic splitter terminal of claim 9, wherein the first sub-compartment comprises a sub-enclosure door.

12. The fiber optic splitter terminal of claim 11, wherein the sub-enclosure door is configured to engage the splitter module when the sub-enclosure door is in a closed position.

13. The fiber optic splitter terminal of claim 12, wherein the sub-enclosure door isolates the first subcompartment when the sub-enclosure door is in the closed position

14. The fiber optic splitter terminal of claim 12, wherein the input leg of the splitter module and the plurality of output legs of the splitter module are protected when the sub-enclosure door is in the closed position.

15. The fiber optic splitter terminal of claim 11, wherein the sub-enclosure door engages the splitter module when the sub-enclosure door is in the closed position.

16. A fiber optic splitter terminal comprising:
a terminal enclosure forming an interior compartment having a first sub-compartment and a second sub-compartment;
at least one fiber optic adapter panel disposed in the terminal enclosure having a first side facing the first sub-compartment and a second side facing the second sub-compartment, the at least one fiber optic adapter panel comprising:
a plurality of first fiber optic adapters disposed in the at least one fiber optic adapter panel, each of the plurality of first fiber optic adapters configured to connect to a respective distribution cable on the second side of the at least one fiber optic adapter panel; and
a plurality of second fiber optic adapters disposed in the at least one fiber optic adapter panel, each of the plurality of second fiber optic adapters configured to connect to a respective subscriber cable on the second side of the at least one fiber optic adapter panel; and
a plurality of splitter modules disposed at least partially in the first sub-compartment, each splitter module comprising:
a splitter enclosure;
a splitter disposed in the splitter enclosure, the splitter comprising:
an input leg comprising a first optical fiber having a first fiber optic connector configured to connect to a respective first fiber optic adapter on the first side of the at least one fiber optic adapter panel; and
a plurality of output legs, each output leg comprising a second optical fiber having a second fiber optic connector configured to connect to a respective second fiber optic adapter on the first side of the at least one fiber optic adapter panel;
wherein the plurality of splitter modules are stacked with respect to each other in the interior compartment.

17. The fiber optic splitter terminal of claim 16, wherein the first sub-compartment comprises a sub-enclosure door.

18. The fiber optic splitter terminal of claim 16, wherein the sub-enclosure door is configured to engage the splitter module when the sub-enclosure door is in a closed position.

19. The fiber optic splitter terminal of claim 18, wherein the sub-enclosure door isolates the first subcompartment when the sub-enclosure door is in the closed position.

20. The fiber optic splitter terminal of claim 18, wherein the sub-enclosure door aligns with the at least one fiber optic adapter panel.
